(19) United States
(12) Patent Application Publication
(10) Pub. No.: US 2002/0172263 A1
(43) Pub. Date: Nov. 21, 2002

(54) Method and apparatus for interfacing to a radio frequency unit

(76) Inventors: Daniel R. Kindred, La Jolla, CA (US); Joseph Burke, Carlsbad, CA (US); Ziad Mansour, San Diego, CA (US)

Correspondence Address: Qualcomm Incorporated, Patents Department, 5775 Morehouse Drive, San Diego, CA, 92121-1714, US

(21) Appl. No.: 09/741,328

(22) Filed: Dec. 20, 2000

(51) Int. Cl. H04B 1/713

(52) U.S. Cl. 375/132

(57) ABSTRACT

A radiotelephone comprises both a Mobile Station Modem, a Bluetooth radio frequency unit, an interface between them and other supporting hardware/software, allowing utilization by a subscriber to implement a truly Universal remote control device. An embodiment of the present invention includes an interface for connecting a mobile station modem to a radio frequency unit equipped for transmitting and receiving a frequency hopped signal, a serial bus interface operably connected between the Mobile Station Modem and the Bluetooth radio frequency unit including a plurality of bi-directional serial data connections. The preferred embodiment further includes a bi-directional serial data connection for transmitting data for transmission connected between the Mobile Station Modem and the Bluetooth radio frequency unit and a synchronous detector and transmit enabling serial data connection for receiving an enabling indication valid data at said radio frequency unit from the Mobile Station Modem.

### Related Applications

This application is related to co-pending applications Attorney Docket No. 010064, Ser. No. ______ entitled “METHOD AND APPARATUS FOR COMMUNICATING WITH A PERIPHERAL MODEM” and Attorney Docket No, 000206, Ser. No. ______ entitled “METHOD AND APPARATUS FOR INTERFACING BETWEEN A RADIO FREQUENCY UNIT AND A MODEM”, filed concurrently and all subject to common assignment at filing.

### BACKGROUND OF THE INVENTION

I. Field of the Invention

The present invention relates to digital wireless communication systems. More particularly, preferred embodiments of the invention are directed to a short range radio frequency transceiver unit and an interface thereto.

II. Description of the Related Art

In the field of wireless communications, moving data between long distances is fast becoming the norm. However, moving data the short distances within a building or room is still much more troublesome. The Bluetooth standard for radio connectivity addresses this problem. Bluetooth is a Radio Frequency (RF) technology based on the IEEE 802.11 standard for wireless LANs. Operating in the 2.45 GHz frequency band, the technology will connect devices within a range of up to 100 feet at speeds up to 2 Mbps.

Bluetooth utilizes spread spectrum technology that hops signals from one frequency to another at set time intervals. This method allows for operation in electrically noisy environments while the frequency hopping combined with data encryption provides increased security. An additional feature includes an auto initiate feature. The auto initiate feature requires no user intervention by allowing devices to send and receive information without the user's permission or knowledge.

Through the air connectivity between devices at short range is well known. Infrared links, like the type based on the popular IrDA standard, already allow users to transfer information between compatible devices simply by pointing and beaming. Wireless LANs have also been available for many years. Bluetooth will enable users to connect to a wide range of computing and telecommunications devices without the need to buy. carry, or connect cables. It delivers opportunities for rapid communications with access points, ad hoc connections, and in the future, cable replacement, and possibly for automatic, unconscious, connections between devices. Bluetooth's power-efficient radio technology can be used with: Phones and pagers; Modems; Local area network (LAN) access devices; Headsets; Notebook, desktop, and handheld computers.

More background information may be found on the Bluetooth Special Interest Group (SIG) Internet Web page which may be found at http://www.bluetooth.com, the contents of which is hereby incorporated by reference as of the date of this filing. What is needed is a method and apparatus for efficiently interfacing a wireless modem to a Bluetooth radio frequency transceiver unit with a cost effective design and methodology. Additionally, what is needed is a Code Division Multiple Access (CDMA) wireless modem efficiently interfaced with a Bluetooth radio frequency transceiver unit to allow a wireless telephone to act as a universal interface to a wide variety of consumer electronics and other peripheral devices.

### SUMMARY OF THE INVENTION

The present invention is a novel and improved method and apparatus for connecting a wireless radiotelephone to a number of peripheral devices via the Bluetooth™ interface.

The method and apparatus include an optimized interface between a Mobile Station Modem and a Bluetooth radio frequency unit. A radiotelephone comprises both a Mobile Station Modem, a Bluetooth radio frequency unit, an interface between them and other supporting hardware/software, allowing utilization by a subscriber to implement a truly Universal remote control device. An embodiment of the present invention includes an interface for connecting a mobile station modem to a radio frequency unit equipped for transmitting and receiving a frequency hopped signal, a serial bus interface operably connected between the Mobile Station Modem and the Bluetooth radio frequency unit including a plurality of bi-directional serial data connections. The preferred embodiment further includes a bidirectional serial data connection for transmitting data for transmission connected between the Mobile Station Modem and the Bluetooth radio frequency unit and a synchronous detector and transmit enabling serial data connection for receiving an enabling indication valid data at said radio frequency unit from the Mobile Station Modem.

### BRIEF DESCRIPTION OF THE DRAWINGS

FIG. 1 illustrates a modem/RFU system in which a preferred embodiment of the present invention resides and operates.

FIG. 2 illustrates a Bluetooth Radio Frequency Unit and associated interface to a Mobile Station Modem.

FIG. 3 illustrates a Mobile Station Modem and associated interface to a Bluetooth Radio Frequency Unit.

FIG. 4 illustrates a timing diagram of a Serial Bus Interface between a Bluetooth Radio Frequency Unit and A Mobile Station Modem.

FIG. 5 depicts in flowchart format a method of operation of an interface between a Bluetooth Radio Frequency Unit and A Mobile Station Modem.

### DETAILED DESCRIPTION OF THE PREFERRED EMBODIMENTS

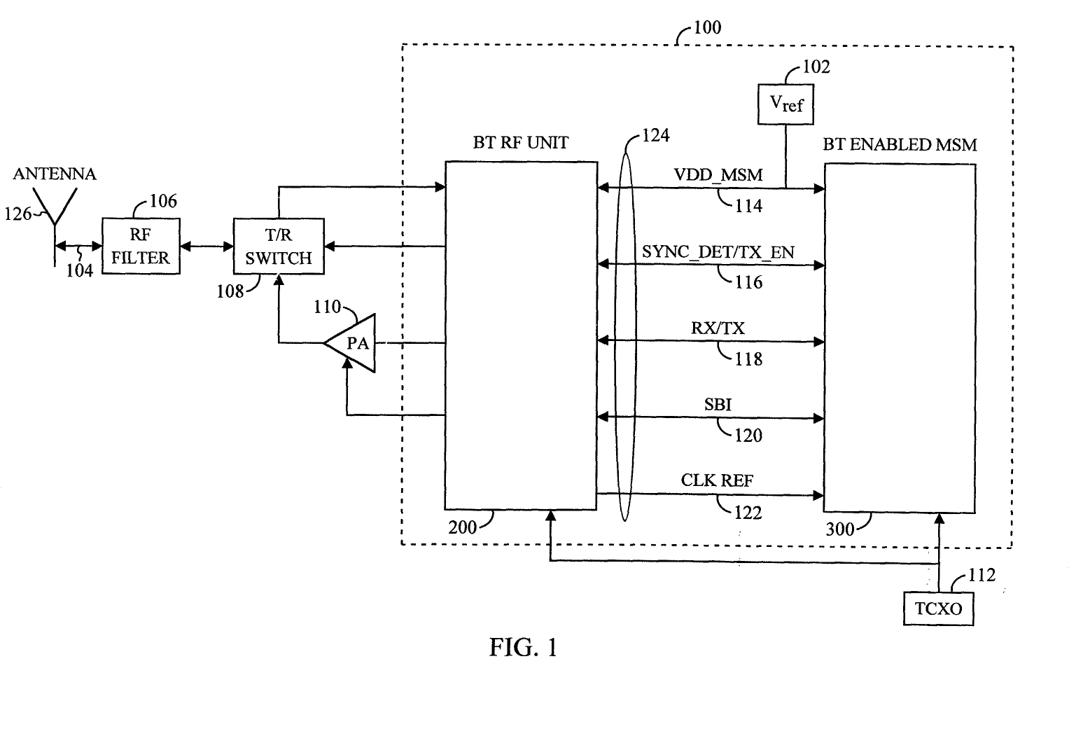

Referring to FIG. 1, System 100 includes a Mobile Station Modem (MSM) 300 coupled to a Bluetooth RF Unit (BT RFU) 200 through an interface 124. System 100 is also connected to oscillator 112 which supplies a timing reference to both MSM 300 and BT RFU 200. BT RFU 200 supplies a Bluetooth compatible signal to Power Amplifier 110, which is then fed into Transmit/Receive (TIR) switch 108 before passing through an RF filter 106 on the path 104 to an antenna 126.

Interface 124 includes multiple signal paths between MSM 300 and BT RFU 200. Bi-directional Rx/Tx signal path 118 transfers data between the MSM 300 and BT RFU 200. Sync-Det/Tx-En (Synchronization Detection/Transmit Enable) path 116 is a path for the Sync-Det/Tx-En signal to be transmitted from MSM 300 to BT RFU 200. This signal indicates to the BT RFU 200 that data is being transmitted from MSM 300 to BT RFU 200 along data path 118.

Voltage reference V_{ref} is supplied to both MSM 300 and BT RFU 200 from V_{ref} 102 along path V_{DD}-MSM 114. A clock reference signal is supplied from BT RFU 200 to MSM 300 on path CLK-Ref 122.

A Serial Bus Interface is supplied between BT RFU 200 and MSM 300 on bi-directional path SBI 120 and is asynchronous to the 12 MHz clock reference supplied on line Clk-Ref 122. In a preferred embodiment, a 3-wire SBI 120 along with Sync-Det/Tx-En 116 comprise the main interface to control and program BT RFU 200 from MSM 300.

The SBI interface 120 operates at clock rates between 100 Khz and 5 MHz. The clocks transition only when the interface is active and in use. During initialization, MSM 300 configures BT RFU 200.The BT RFU is identified by a specific address via the SBI 120. The MSM 300 configures the TCXO frequency and other RFU specific functions.

Functions of the SBI and Sync-Det/Tx-En control lines include programming the hop frequency, received Signal Strength Indicator (RSSI), BT RFU reset, PLL lock indication, Rx-Sel/Tx-Sel, Sync-Det signaling, Power On/Off etc. In a preferred embodiment, the SBI protocol is a subset of the standard general SBI interface used by QUALCOMM.

The independence of the BT RFU allows for direct VCO modulation control and independent control of I/Q modulation.

BT RFU performs the necessary tasks on the Rx path 118 to translate the BT RF signal from 2.4 GHz down to and including Rx path data slicing. MSM 300 performs the symbol recovery. The architecture is optimized to minimize MSM and BT RFU overhead.

MSM 300 receives Rx oversampled data, allowing MSM 300 to perform symbol recovery practically independently of the BT RFU 200. Likewise, BT RFU 200 performs data slicing practically independently of MSM 300.

The amount of real time feedback between MSM 300 and BT RFU 200 for optimal Rx path operation is a signal along Sync-det/Tx-enable path that tells the RFU when the MSM symbol recovery circuits have achieved synchronization with a BT packet.

BT RFU 200 performs the necessary tasks on Tx path 118 to translate the raw baseband data, pre-BT Gaussian Frequency Shift Keyed (GFSK) modulation up to RF frequencies (2.4 GHz). Tx path data Gaussian filter, digital to analog converter (DAC) and other GFSK are located on the BT RFU 200 in a preferred embodiment. The architecture is optimized to insure minimized I/O, one data and one control pin/data path on Tx path 118 and practical independence from RF Phase Locked Loop (PLL).

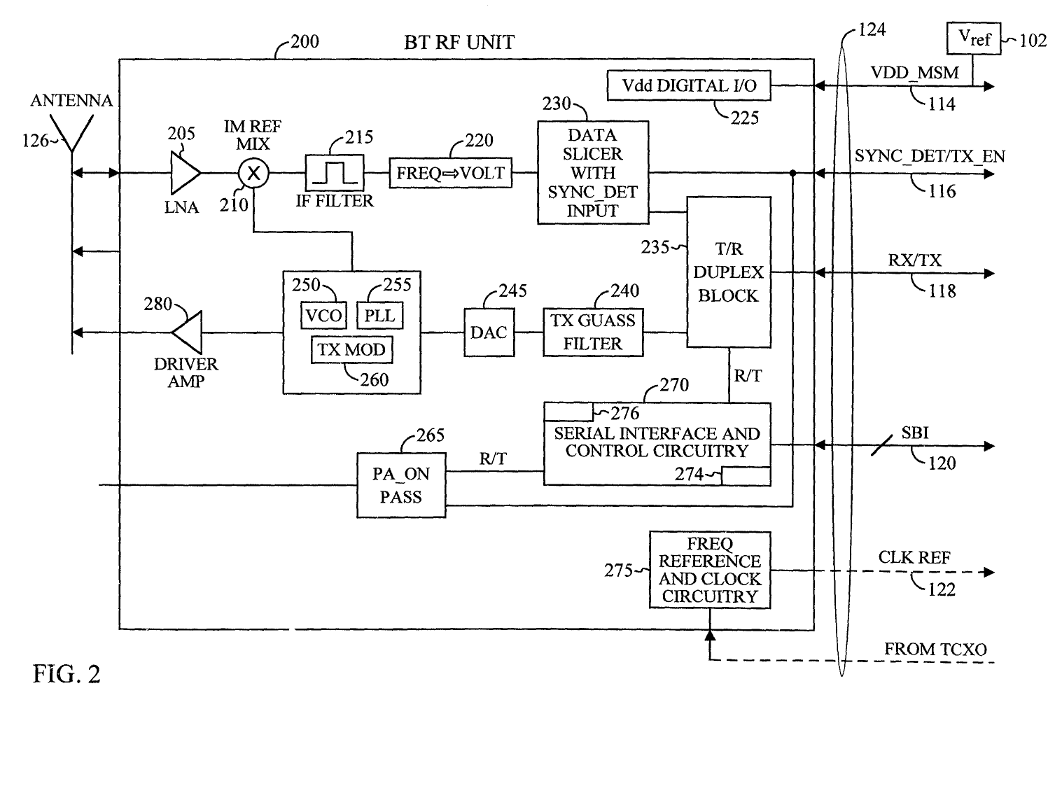

In the exemplary system of FIG. 2, BT RFU 200 is depicted in block diagram form. Interface 124 is connected to BT RFU 200. Vdd Digital I/O 225 receives a reference input from VDD-MSM 114. Low Noise Amplifier (LNA) 205 receives an input signal from antenna 126, where it is downconverted to an appropriate frequency by mixer 210. The downconverted signal is passed through IF filter 215 to a level detector 220 before it is sent to Data Slicer with Sync-Det Input 230. Data Slicer with Sync-Det Input 230, if enabled by the signal from Sync-Det/Tx-En line 116, decimates the oversampled signal for passage to T/R Duplex block 235 where it is placed on Rx/Tx data line 118. If transmission from the BT RFU is enabled, then data from Rx/Tx data line 118 is conveyed to Tx Gaussian Filter 240, and converted to an analog signal in DAC 245. The analog signal is then passed to Transmit Module (Tx Mod) 260 for upconversion using Phase Locked Loop (PLL) 255 and Voltage Controlled Oscillator (VCO) 250 before being passed on to driver amplifier 280 and then to antenna 126.

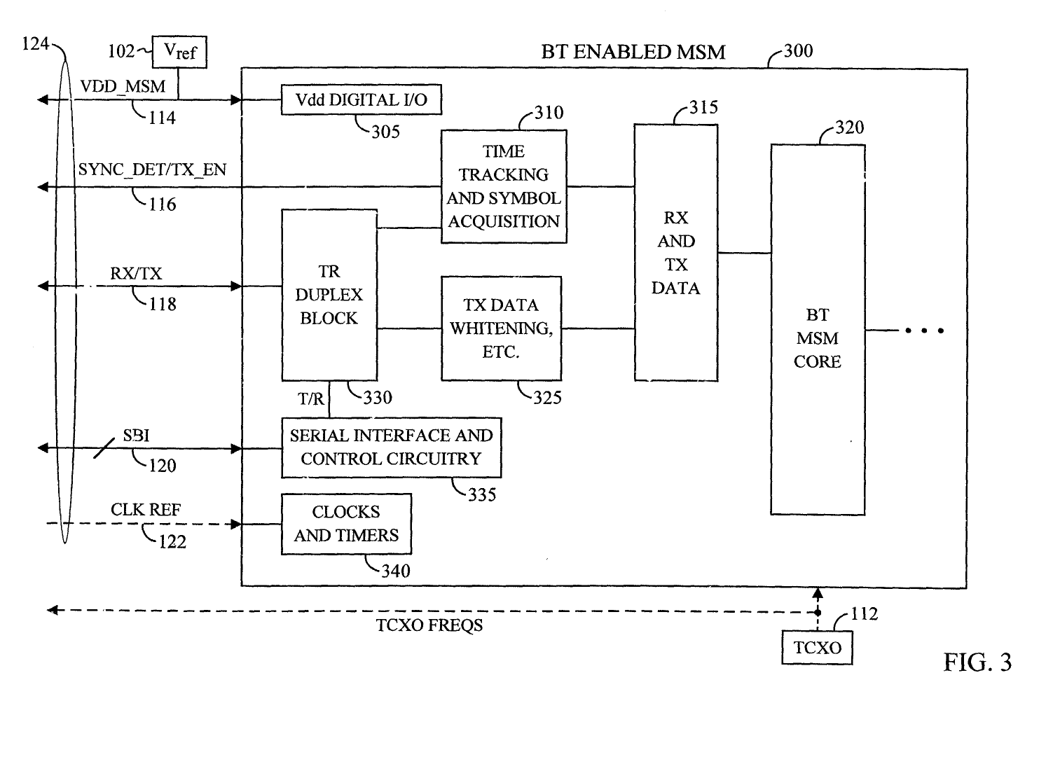

With respect to FIG. 3, MSM 300 is depicted in block diagram form. Interface 124 connects with MSM 300 in a similar fashion that just described with respect to FIG. 2. V_{dd} Digital I/O 305 receives a reference input from V_{DD}-MSM 114. MSM core 320 formats data and control information intended for BT RFU 200 before transmitting data to Rx and Tx data module 315. Appropriate symbols are transmitted to time tracking and symbol acquisition module to enable the Sync Detect/Transmit Enable (Sync-Det/Tx-En) path 116. Sync-Det/Tx-En path 116 is connected to and fed by time tracking and symbol acquisition module 310. Tx Data whitening module 325 is also connected to Rx and Tx data module 315, and in turn transmits/receives data to T/R Duplex block 330. Transmit/control instructions are conveyed over SBI 120 via serial interface and control circuitry 335. Clocks and timers module 340 is connected to clock reference signal path 122 and provides clocking to various components (connections not shown).

### DESCRIPTION BY EXAMPLE

In an exemplary embodiment of the present invention, the interface may be implemented between an MSM device 300 and an RFU device 200 in a mobile phone (not shown) which can use the Bluetooth (BT) RF link 104 to communicate with an external device, such as a PC (not shown) for the purpose of synchronizing an address book. When the phone powers on, the MSM 300 and RFU 200 are reset and the BT interface and logic enters a sleep state. The phone software may also force a sleep state by issuing a Serial Bus Interface (SBI) write to the RFU RESET register and resetting the MSM logic. The phone user may request synchronization of the address book by pressing a key on the phone. The phone software detects this key press and establishes a BT RF link with the PC. The address book data is transferred over the RF link and then the link is disconnected. The procedure to establish the link requires many protocol steps but for the BT interface and logic the identical sequences to send and receive packets are repeated over and over. Each time the phone software receives a packet the following sequence is performed:

The MSM 300 awakens the RFU 200 from the sleep state by an SBI write to the CONFIG register 272 within the serial interface and control circuitry 270. The BT interface and logic will then be in an idle state.

The MSM 300 begins the receive sequence with an SBI write to the RFU HOP register 274 to set the receive mode and frequency. This arms the RFU and puts the BT interface and logic in the ready state.

The RFU timing will be set precisely by a strobe from the MSM to RFU on the Sync_Det/Tx_En 116 hardware signal which sets the BT interface and logic into the start state. In the start state the RFU initializes its logic, warms up the frequency synthesizers and begins a sending data stream to the MSM after 180us.

When the MSM detects a synchronization pattern for a data packet in the data stream it sets the Sync_Det/Tx_En 116 signal high to put the BT interface and logic into the go state.

At the end of the receive data packet the Sync_Det/Tx_En 116 goes low and the BT interface and logic returns to the idle state.

The transmit sequence is similar to the receive sequence except that the transmit mode is set in the HOP register. After the phone has used the receive and transmit sequences to send protocol messages and establish a link, the same receive and transmit sequences will be used to transfer the address book data. When the data transfer is complete the BT link will be shut down and the BT interface and logic returned to the sleep state.

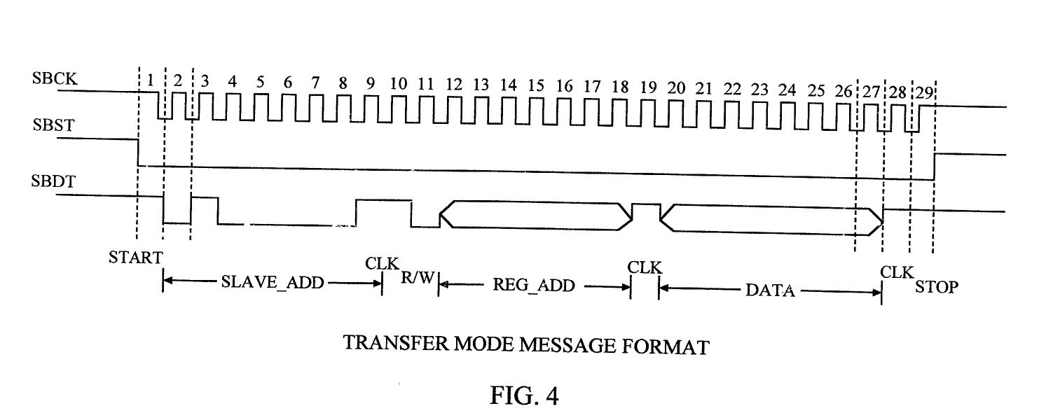

FIG. 4 is a timing diagram of the 3 wire Serial Bus Interface (SBI) 120. As shown in a preferred embodiment, signal SBCK is rapidly oscillating clock signal, that when logically combined with signal SBST when held to a logical low enables the data transfer through data signal and line SBDT.

The SBI write registers are reset to 0 and bidirectional pins are put into an input state by an BT RFU 200 detection of a power up reset condition or by a write to the SBI reset register. These resets put the BT RFU 200 in a low power mode with the SBI interface still operational. The state of the BT RFU write registers is maintained as long as power is supplied, regardless of the state of the clocks.

The SBI write registers inside the BT RFU are as follows in Tables 1 and 2:

TABLE 1

| REG_ADD | Bit # | Name | Description |
|---|---|---|---|
| 0x00 | — | Reset | Write to address resets RFU. |
| 0x01 | 6:0 | Hop | Hop frequency for this slot. |
| | | | f = 2400 MHz + Hop MHz |
| 0x01 | 7 | Rx_Sel/ | A write to the hop register will |
| | | Tx_Sel | enable either the receive or |
| | | | transmit mode as selected |
| | | | by this bit. |
| | | | A 1 is to select Rx and a 0 selects |
| | | | Tx. The low to high (active) |
| | | | transition of the |
| | | | Sync_Det/Tx_En pin will |
| | | | start RFU timing for |
| | | | the selected mode. |
| 0x02 | 0 | Sleep/ | 0 sets the RFU immediately into |
| | | | sleep mode and inactive except for |
| | | | the SBI interface and Clk_Ref. |
| | | | 1 takes the RFU out of sleep mode |
| | | | and allows other portions of RFU |
| | | | to be turned on with their specific |
| | | | signaling |
| 0x02 | 1 | CLK_On | 1 turns on 12 MHz clock output. |
| | | | Set to 0 to turn off 12 MHz clock |
| | | | output and force Clk_Ref to 0. |
| 0x02 | 3:2 | PLL_Sel | Select the input clock frequency. |
| | | | 00 = 19.2 MHz |
| | | | 01 = 19.68 MHz |
| | | | 10 = 19.8 Mhz |
| | | | 11 = External 12 Mhz xtal |
| 0x03 | 4:0 | Pwr_Cntl | Output attenuation in 2 dB steps. |
| | | | 0x00 = 0 dB attenuation and |
| | | | 0x1F = 62 dB attenuation. |
| | | | Accuracy is ±2 dB. |
| 0x04 | 7:0 | assigned | TBD |
| 0x05-0x3F | — | — | Reserved. |
| 0x40-0x7F | — | — | Write registers available for device |
| | | | testing. |

TABLE 2

| REG_ADD | Bit # | Name | Description |
|---|---|---|---|
| 0x80 | — | — | Reserved. |
| 0x81 | 3:0 | ID | Device identification number. |
| 0x81 | 7:4 | ID | TBD. Manufacturer ID number. |
| 0x82 | 6:0 | RSSI | Receive Signal Strength |
| | | | Indicator. 0 to −127 dBm. The |
| | | | value is latched at the second |
| | | | Sync_Det/Tx_En rising |
| | | | edge during a receive slot |
| | | | i.e. the end of the sync id |
| | | | sequence and shall have an |
| | | | accuracy of ±4 dB within the |
| | | | range −20 dBm to −80 dBm. |
| 0x82 | 7 | PLL_{—} | 1 when PLL lock detected. |
| | | Lock | |
| 0x83-0xBF | — | — | Reserved. |
| 0xC0-0xFF | — | — | Read registers available for |
| | | | device testing. |

The SBI data transfer format is composed of 29 fixed bits as illustrated in FIG. 4 and as follows in Table 3:

TABLE 3

| Bit | Name | Description |
|---|---|---|
| 1 | Start | Always 1. Falling edge of SBCK only. |
| 2-9 | SLAVE_ADD | 0 × 41 for the RFU. |
| 10 | CLK | Always 1. |
| 11 | R/W | MSBit of register address byte. |
| | | 1 when Data is transferred from Slave to |
| | | Master. |
| | | 0 when Data is transferred from Master to |
| | | Slave. |
| 12-18 | REG_ADD | 7 LSBits of register address. |
| 19 | CLK | Always 1. |
| 20-27 | Data | 8 bits of data. MSB at cycle 20. |
| 28 | CLK | Always 1. |
| 29 | Stop | Always 1. Rising edge of SBCK only. |

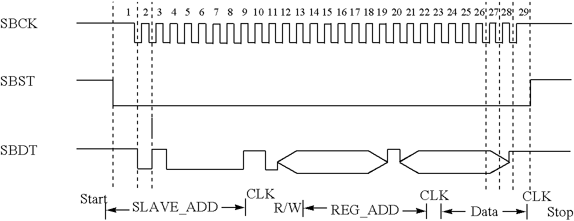

The sequence of information shown adjacent to SBDT is device address, register address and then the data, with each field transmitted with the most significant bit first. Control data is transferred between MSM 300 and BT RFU 200 one byte at a time. Control bits become effective during the CLK cycle at bit 28. Whn status data from the slave device (BT RFU) is being read, the data pin is driven by the BT RFU only during the 8 clock cycles of the Data field Bit 11 of Table 3.

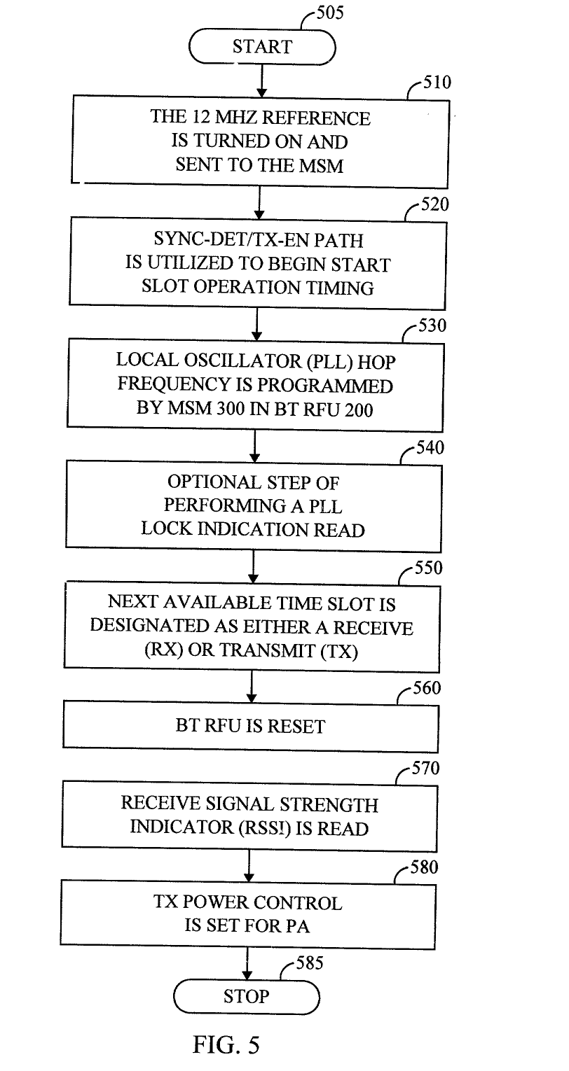

With respect to FIG. 5, the normal continuous operation of System 100 will be detailed beginning with START 505. During normal operations, the following functions are performed over SBI 120. The 12 MHz reference is turned on and sent to the MSM 300 core in step 510. In step 520, the Sync-Det/Tx-En path is utilized to begin Start Slot operation timing,. In step 530 the Local oscillator (PLL) hop frequency is programmed by MSM 300 in BT RFU 200. In step 540, the optional step of performing a PLL lock indication read is undertaken. In step 550, the next available time slot is designated as either a receive (Rx) or transmit (Tx) from the unit as a whole. The BT RFU is then reset in step 560, while in step 570 the Receive Signal Strength Indicator (RSSI) is read. Finally, the transmit (Tx) power control is set for Power Amplifier (PA) 110 in step 580 before control passes to STOP 585. Of course control returns to START and the process repeats indefinitely until some action or condition interrupts the process.

The previous description of the preferred embodiments is provided to enable any person skilled in the art to make or use the present invention. The various modifications to these embodiments will be readily apparent to those skilled in the art, and the generic principles defined herein may be applied to other embodiments without the use of the inventive faculty. Thus, the present invention is not intended to be limited to the embodiments shown herein but is to be accorded the widest scope consistent with the principles and novel features disclosed herein.

What is claimed:

1. An interface apparatus for connecting a mobile station modem to a radio frequency unit equipped for transmitting a frequency hopped signal including:
a bus interface operably connected to said radio frequency unit including a plurality of bi-directional serial data connections;
a bi-directional serial data connection for transmitting data for transmission in a first direction from said radio frequency unit and for receiving data at said radio frequency unit;
a synchronous detector and transmit enabling serial data connection for receiving an enabling indication of valid data at said radio frequency unit from an external source.

2. The apparatus of claim 1 further including a transmitter for sending a first signal to begin timing.

3. The apparatus of claim 2 wherein said first signal is a synchronization detect signal.

4. The apparatus of claim 2 wherein said first parameter includes a frequency hop rate.

5. The apparatus of claim 2 including interface circuitry for designating a next available time slot in a plurality of states.

6. The apparatus of claim 5 wherein said next available time slot is a read time slot.

7. The apparatus of claim 5 wherein said next available time slot is a write time slot.

8. The apparatus of claim 5 wherein said next available time slot is selectable as one of a read and a write time slot.

9. The apparatus of claim 4 wherein said interface is a serial interface.

10. The apparatus of claim 5 wherein said interface circuitry further includes a received signal strength measurement module.

11. A. method of interfacing between a mobile station modem and a radio frequency unit equipped for transmitting a frequency hopped signal wherein the interface includes a serial bus interface operably connected to the radio frequency unit including a plurality of bi-directional serial data connections; a bi-directional serial data connection for transmitting data for transmission in a first direction from the radio frequency unit and for receiving data at the radio frequency unit; a synchronous detector and transmit enabling serial data connection for receiving an enabling indication valid data at the radio frequency unit from an external source, the method including the steps of:
a) sending a wakeup signal to the radio frequency unit via a serial bus interface; and
b) writing to a first register within the serial interface and control circuitry to set the logic to an idle state.

12. The method of claim 11 wherein step a) includes sending the wakeup signal from the modem.

13. The method of claim 12 further including the step of:
c) writing from the modem via the serial bus interface to a second register to initialize at least one parameter.

14. The method of claim 13 wherein step c) further includes writing to a second register from the modem.

15. The method of claim 14 further including the step of:
d) sending a synchronization detection signal from the modem to the radio frequency unit to begin the receive process.

16. The method of claim 15 further including the step of:
e) sending a second synchronization signal for re-enabling the idle state.

17. The method of claim 16 wherein in step e) the second synchronization signal is sent from the modem.

18. The method of claim 17 wherein in step e) the second synchronization signal is sent to the radio frequency unit.

19. A method of interfacing between a mobile station modem and a radio frequency unit equipped for transmitting a frequency hopped signal wherein the interface includes a serial bus interface operably connected to the radio frequency unit including a plurality of bi-directional serial data connections; a bi-directional serial data connection for transmitting data for transmission in a first direction from the radio frequency unit and for receiving data at the radio frequency unit; a synchronous detector and transmit enabling serial data connection for receiving an enabling indication valid data at the radio frequency unit from an external source, the method including the steps of:
a) enabling a first signal to begin timing;
b) sending a signal to the radio frequency unit to program a first parameter;
c) repeatedly designating a next available time slot as either read or write;
d) reading a predetermined received signal parameter;
e) transmitting said predetermined parameter by said radio frequency unit to an external destination;
f) repeating steps c-e until a predetermined status is detected.
